(19) United States
(12) Patent Application Publication
(10) Pub. No.: US 2012/0104117 A1
(43) Pub. Date: May 3, 2012

(54) SPRAY HEAD

(75) Inventors: Harri Mattila, Hyvinkaa (FI); Sebastien Cailliau, Helsinki (FI); Jarmo Helasuo, Espoo (FI)

(73) Assignee: MARIOFF CORPORATION OY, Vantaa (FI)

(21) Appl. No.: 13/381,549

(22) PCT Filed: Jun. 14, 2010
(86) PCT No.: PCT/FI2010/050497

§ 371 Date: Dec. 29, 2011

(30) Foreign Application Priority Data
Jun. 30, 2009 (FI) 20095741

(51) Int. Cl. B05B 1/28

(52) U.S. Cl. 239/288

(57) ABSTRACT

Spray head, which comprises a spray head body (2), which comprises at least one nozzle (3), a heat-activated triggering element (5), in connection with the spray head of which a protection means (6) is arranged, which protection means is in front of the nozzle (3) in the protective position and mechanically protects the triggering element (5) when the spray head is in a non-active state, and which protection means (6) can be moved to a second position, in which at least one nozzle (3) and the triggering element (5) are not protected by the protection means (6). The triggering element (5) is fitted onto the fixing body (4) of the triggering element, which fixing body can be moved with respect to the spray head body (2) between two positions, a first position in which the spray head is in the non-active state and the fixing body (4) of the triggering element is in the retracted position, and a second position in which the fixing body (4) of the triggering element is pushed out, and which fixing body (4) of the triggering element is arranged to move with respect to the spray head body (2) from the effect of the pressure of the medium from a first position to a second position and at the same time to exert a force on the protection means (6), for moving the protection means from the protective position to a second position, in which case the spray head is placed into a state of readiness in the second position of the fixing body of the triggering element.

### BACKGROUND OF THE INVENTION

The object of the invention is a spray head as defined in the preamble of claim 1, which comprises a spray head body, which comprises at least one nozzle, a heat-activated triggering element, in connection with the spray head of which a protection means is arranged, which protection means is in front of the nozzle in the protective position and mechanically protects the triggering element when the spray head is in a non-active state, and which protection means can be moved to a second position, in which at least one nozzle and the triggering element are not protected by the protection means.

One such spray head intended particularly for fire extinguishing is known e.g. from publication EP 1150747. The dome part that protects the nozzles of the spray head and the triggering element is released with a device that can be moved with respect to the holder body. The publication presents some different alternatives for releasing the dome part and for getting the spray head into a position of readiness.

A solution is also known from publication WO 2007/082988 A1, a sprinkler, in which the sprinkler body is formed to be movable and the sprinkler body exerts a force influence on a protection means that releases the protection means. In the solution of the publication in question, the release of the protection means is achieved by arranging a relatively large part of the sprinkler, in terms of its mass, to be movable. This forms a sprinkler that is relatively complex in structure and makes the manufacturing costs of the component in question rather high. In addition, the solution according to the publication becomes rather big in its height, which is a significant drawback in applications in which the space available for the spray head is minimized. These types of applications are, among others, means of transportation, such as train carriages, or public spaces.

The aim of this invention is to achieve a new type of spray head, the space requirement of which is minimal and by means of which the protection means can be dependably and effectively removed from in front of the spray nozzle and the triggering element. Another aim is to achieve, among other things, a simpler combination for a spray head that is excellent in terms of its operational reliability, more particularly for a spray head and for apparatuses for releasing the protection means of the spray head.

### BRIEF DESCRIPTION OF THE INVENTION

The invention is based on a concept wherein the fixing body of the triggering means of the spray head is arranged to be moved between two positions, in which case the fixing body of the triggering means of the spray head functions as a releasing means of the protection means.

The spray head according to the invention is characterized in that the triggering element is fitted onto the fixing body of the triggering element, which fixing body can be moved with respect to the spray head body between two positions, a first position in which the spray head is in the non-active state and the fixing body of the triggering element is in the retracted position, and a second position in which the fixing body of the triggering element is pushed out, and which fixing body of the triggering element is arranged to move with respect to the spray head body from the effect of the pressure of the medium from a first position to a second position and at the same time to exert a force on the protection means, for moving the protection means from the protective position to a second position, in which case the spray head is placed into a state of readiness in the second position of the fixing body of the triggering element.

The apparatus according to the invention is also characterized by what is stated in claims 2-10.

The solution according to the invention has a number of important advantages. By arranging the fixing body of the triggering means of the spray head to be movable and by using it to release the protective dome, an extremely well-functioning solution is obtained for bringing a spray head intended for difficult conditions into a state of readiness. By using the extinguishing medium for moving the spray head, an advantageous combination for a means for removing the protection means from in front of the spray head is achieved. By using the valve spindle, or a part of it, of the spray head as a fixing body of the triggering means, sufficiently large surfaces can be obtained for converting the pressure of the medium into a moving force exerted on the protection means. By arranging the triggering element transversely on the fixing body, a space-saving construction is achieved. The spray head arrangement according to the invention can thus easily be connected to the applicable fixing parts. The solution is extremely well suited for disposing in circumstances in which protection of the spray head from, among other things, environmental conditions is necessary. These types of circumstances are e.g. public premises in which the available space is limited, such as means of transportation, e.g. trains. The solution is extremely well suited in particular to fire extinguishing applications, and more particularly to applications in which a medium mist of high liquid content is used as an extinguishing medium.

### BRIEF DESCRIPTION OF THE FIGURES

In the following, the invention will be described in more detail by the aid of an embodiment with reference to the attached drawing, wherein

FIG. 1 presents an apparatus according to the invention as a partial cross-section in a first position,

FIG. 2 presents an apparatus according to the invention as a partial cross-section in a second position, i.e. in a position of readiness,

FIG. 3 presents an apparatus according to the invention as a partial cross-section in a third position, i.e. activated, and

FIG. 4a presents a simplified cross-section of a spray head according to the invention,

FIG. 4b presents a simplified view of a spray head according to the invention as a cross-section along the line B-B of FIG. 4a.

### DETAILED DESCRIPTION OF THE INVENTION

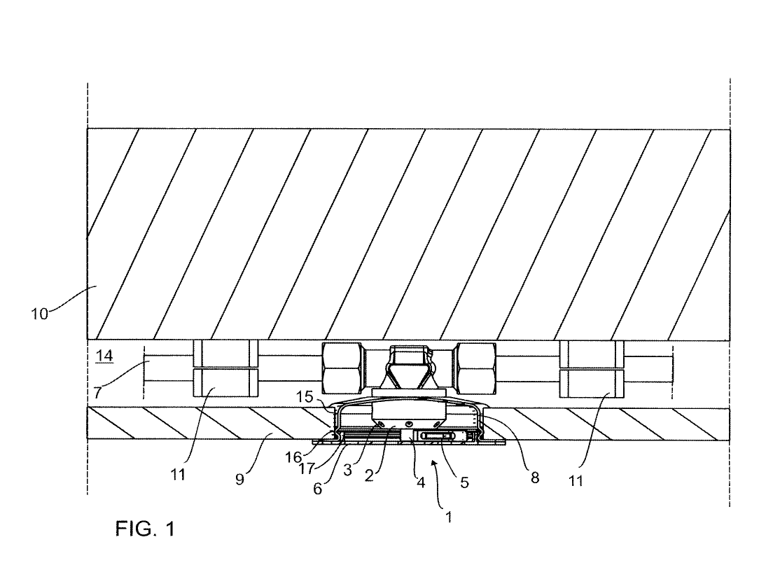

FIG. 1 presents a spray head 1 according to the invention arranged on a fixing surface 10, such as on a ceiling, wall or corresponding surface. A pipeline 7, or corresponding medium conduit, is arranged to the spray head, with which the medium to be sprayed is brought to the spray head. The pipeline is fixed to the fixing surface 10 with fastening devices 11. The wall or the ceiling structure comprises a cover board 9, such as a suspended ceiling, which is at a distance from the fixing surface, in which case a space 14 remains between the fixing surface 10 and the cover board 9 for the pipeline 7. An aperture 15 is formed in the cover board 9. A mounting box 8 is arranged in the aperture 15, the wall and base of which mounting box extend inwards from the aperture 15, i.e. in the figure towards the pipeline 7. A protection means 6 is arranged in front of at least one nozzle 3 of the spray head and in front of the triggering element 5. The protection means 6 in the embodiment of FIG. 1 is a plate, which is arranged to cover the aperture 15 and the spray head 1. A fastening means 17, which is arranged to suit a counterpart 16, is arranged on the protection means. The counterpart 16 is arranged in the mounting box 8 in the embodiment of the figures, but it can also be on the cover board 9, such as on the wall of the aperture 15. Alternatively, the protection means is arranged in the spray head. In this case the shape of the protection means can be e.g. domed.

FIG. 1 presents a spray head 1 as a partial cross-section in a first position. The spray head is arranged on a fixing part that is arranged on the pipeline 7. The body part of the spray head, i.e. the spray head body 2, is arranged on the fixing part.

A triggering means 5, such as a heat-sensitive triggering means, e.g. an ampoule that breaks at a certain temperature, is arranged in the spray head. The triggering means 5 is arranged on the fixing body 4 of the triggering element.

The triggering means 5 in the embodiment of the figure is fitted to extend in a space-saving manner in the lateral direction with respect to the fixing body 4 of the triggering element. The triggering element extends in the side direction in FIG. 1, i.e. essentially in the direction of the cover board. The triggering means 5 is in this case according to FIG. 1 between the spray head body 2 and the protection means 6.

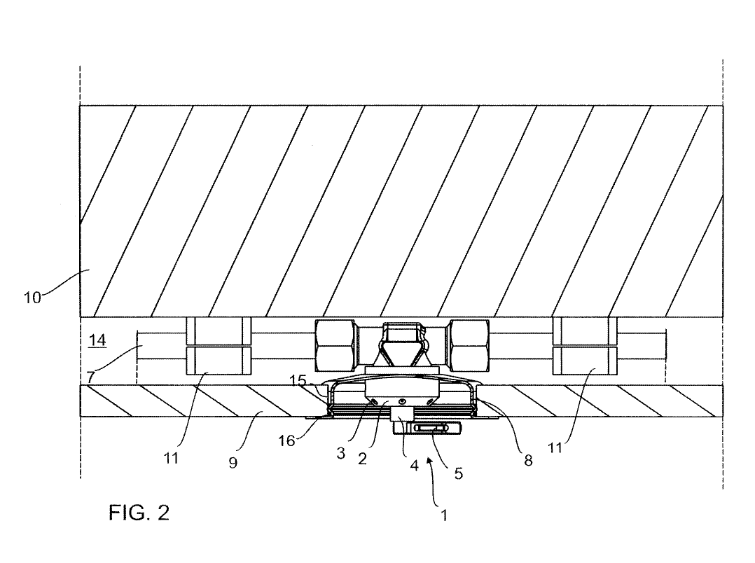

The fixing body 4 of the triggering means is fitted to move with respect to the spray head body 2 at least between a first position, i.e. a non-active position, (FIG. 1), and one second position, i.e. a position of readiness (FIG. 2).

At least one nozzle 3 is arranged in the body part 2 of the spray head. The spray head of the figure comprises a number of nozzles 3.

A duct 13 is arranged in the spray head body 2, in which duct the fixing body 4 of the triggering element can move between a first position and a second position. When the pressure of the medium in the piping 7 increases, the pressure acts on the surfaces of the fixing body of the triggering means, which surfaces are formed to be such that the fixing body of the triggering means moves from a first position in the duct 13 of the body part to a second position, i.e. up to the countersurface 18 of the duct space of the spray head body. The fixing body 4 of the triggering means comprises a shoulder 12, which corresponds to the countersurface 18 of the duct space of the spray head body. The shoulder 12 thus functions as a limiter part. As a consequence of the moving of the fixing body 4 of the triggering means, the end 41 of the fixing body 4 on the protection means 6 side and/or the triggering element 5 acts on the protection means 6. The protection means 6 detaches from the locked position (FIG. 1) and moves away from the front of the triggering means 5 and the nozzles of the spray head body (FIG. 2).

The spray head comprises a spray head body 2, which comprises at least one nozzle 3, a heat-activated triggering element 5 and a protection means 6, which protection means is in front of the nozzle 3 and mechanically protects the triggering element 5 when the spray head is in a non-active state, and which protection means 6 can be moved to a second position, in which the nozzles 3 and the triggering element 5 are not protected by the protection means 6.

The fixing body 4 of the triggering element can be moved with respect to the spray head body 2 between two positions, a first position in which the spray head is in the non-active state, and a second position in which the fixing body 4 of the triggering element is pushed out, and which fixing body 4 of the triggering element is arranged to move with respect to the spray head body from the effect of the pressure of the medium from a first position to a second position and at the same time to exert force on the protection means 6 for moving it from the protective position to a second position, in which case the spray head is placed into a state of readiness in the second position of the fixing body 4 of the triggering element. The spray head body 2 comprises a duct part 13, i.e. a cylinder space, in which case at least a part of the fixing body 4 of the triggering element is formed into a piston part, which is arranged to move in the cylinder space from the effect of the pressure of the medium from a first position to a second position.

In one embodiment the medium used for moving is typically an extinguishing medium. It is also possible to use some other applicable medium.

A protection means 6, which protects the triggering means 5 and the nozzles 3, is arranged in connection with the spray head. The protection means 6 is fixed in the solution according to FIG. 1 in the protective position (FIG. 1) into a ring-shaped counter-element 16 of the wall of the mounting box 8 arranged in the aperture 15 of the cover board 9. The ring-shaped counter-element 16 is arranged on the wall of the mounting box 8. A fixing part 17 is on the protection part 6. The fixing part 17 of the protection part and the ring-shaped counterpart 16 form a locking, which keeps the protection part in its position in the protective position. The protection means 6 stays in its position well in the protective position, in which case the important parts of the spray head are well protected from the effects of the environment of the spray head. These types of parts that are intended to be protected are, among others, the triggering means 5, typically an ampoule, and the nozzles 3. The spray head can be disposed in very different environments, in which it is subjected to impurities and to dirt or to vandalism, which may impair the operation of the spray head to, among other things, cause malfunctions of the spray head without the protection means 6. On the other hand, the protection means 6 prevents unwanted triggering of the triggering means 5, e.g. as a result of a short hot gas current directed onto the spray head. These types of situations can occur in, among other places, highway tunnels, in which e.g. the exhaust gas of a truck can momentarily be aimed directly towards the spray head, or as a result of vandalism, in which e.g. the flame of a lighter is deliberately aimed at the spray head.

The spray head can be placed into a state of readiness by conducting the medium into the pipe 7 with pressure. As a consequence of this the pressure of the medium is exerted against the surfaces of the fixing body of the triggering means of the spray head, in which case a force is produced that presses the fixing body of the triggering element from a first position in the spray head body towards a second position, i.e. downwards in FIG. 1. The fixing body 4 of the triggering element, for its part, acts on the protection means 6, in which case when the force exerted by the fixing body 4 of the triggering element on the protection means 6 exceeds the force that keeps the protection means in its position, the protection means detaches from its position to the non-protective position according to FIG. 2. The fixing body in the figure acts at the point of its outermost part, i.e. the support part 41, on the protection means 6 in the direction of movement of the fixing body.

In the state of readiness (FIG. 2) the spray head can be activated in the normal way by the aid of the triggering means 5, e.g. when it is broken from the effect of heat, in which case the nozzles 3 can spray extinguishing medium. In the state of readiness, the first end of the fixing body of the triggering element according to the invention extends to some extent away from the spray head body, in which case it is, on the one hand, closer to a possible burning object and also a distance from the fixing point, e.g. from the surface of the ceiling or wall.

Typically the extinguishing medium pipe 7 is a so-called dry pipe, in which case there is no extinguishing medium in it. When the extinguishing medium is conducted into the pipe 7, the extinguishing medium acts in the manner described above moving the fixing body of the triggering element from a first position to a second position and into a state of readiness, in which case also the protection means 6 detaches from its locking. In the state of readiness after the ampoule 5 of the spray head has broken, e.g. from the effect of heat, extinguishing medium starts to spray from the nozzles 3 of the spray head.

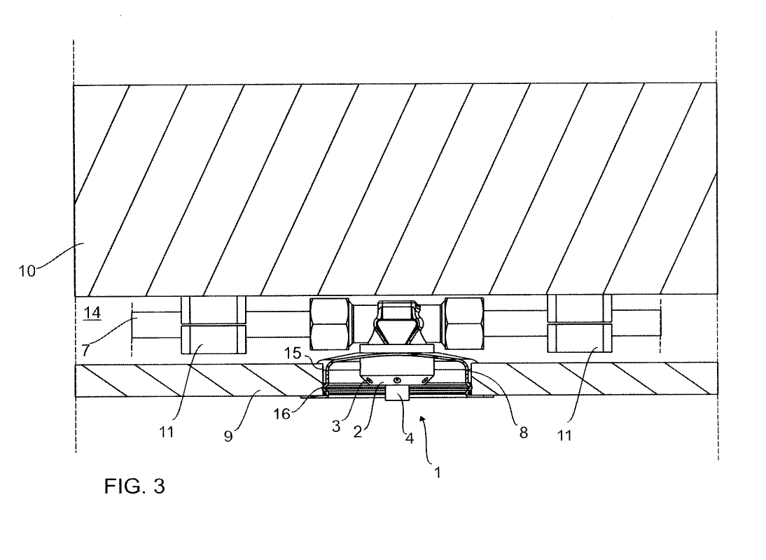

FIG. 3 presents a spray head according to the invention when activated, in which case the triggering element has broken and at the same time the support part 41 of the triggering element has detached from the moving body 4 of the triggering element. In this case there is no part in front of the nozzles that possibly impedes the spraying.

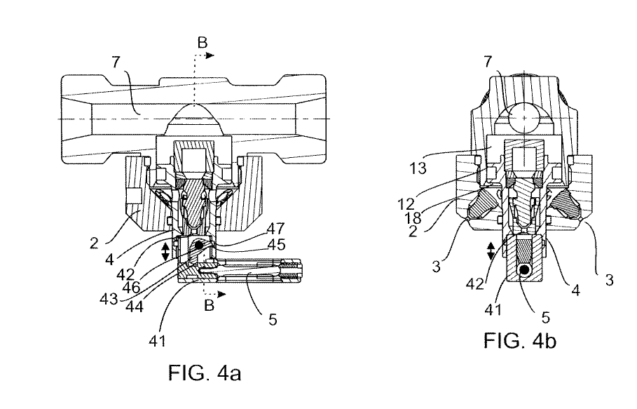

FIGS. 4a and 4c further present a cross-section of one spray head according to the invention.

The invention thus relates to a spray head, which comprises a spray head body 2, which comprises at least one nozzle 3, a heat-activated triggering element 5, in connection with the spray head of which triggering element a protection means 6 is arranged, which protection means is in front of the nozzle 3 in the protective position and mechanically protects the triggering element 5 when the spray head is in a non-active state, and which protection means 6 can be moved to a second position, in which at least one nozzle 3 and the triggering element 5 are not protected by the protection means 6. The triggering element 5 is fitted onto the fixing body 4 of the triggering element, which fixing body can be moved with respect to the spray head body 2 between two positions, a first position in which the spray head is in the non-active state and the fixing body 4 of the triggering element is in the retracted position, and a second position in which the fixing body of the triggering element is pushed out, and which fixing body 4 of the triggering element is arranged to move with respect to the spray head body 2 from the effect of the pressure of the medium from a first position to a second position and at the same time to exert force on the protection means 6, for moving the protection means from the protective position to a second position, in which case the spray head is placed into a state of readiness in the second position of the fixing body of the triggering element.

According to one preferred embodiment the spray head body 2 comprises a cylinder space 13, and at least a part of the fixing body 4 of the triggering element is formed into a piston part, which is arranged to move in the cylinder space 13 from the effect of the pressure of the medium from a first position to a second position.

According to one preferred embodiment the fixing body 4 of the triggering element comprises a limiting means 12 of movement, such as a shoulder, and the spray head body 2 comprises a countersurface 18 to the limiting means.

The triggering element 5 is preferably fitted to extend in the lateral direction with respect to the direction of movement of the fixing body 4 of the triggering element.

According to one preferred embodiment the fixing body 4 of the triggering element comprises a support part 41, which is fitted to the end of the fixing body 4 of the triggering element on the protection means 6 side, when the protection means 6 protects the triggering element and at least one nozzle 3 of the spray head.

According to one embodiment, in the protective position the protection means 6 is fitted into the aperture 15 of the cover board 9, into the mounting box 8, or into a corresponding installation aperture of the spray head.

According to one preferred embodiment the support part 41 of the fixing body 4 of the triggering element is fitted to detach when the triggering element 5, such as an ampoule that breaks from the effect of heat, triggers and the spray head activates to spray.

The spray head comprises a locking means 43, which comprises a first claw part 44 and a second claw part 45. The locking means 43 is fitted in a manner allowing rotation onto a support axle 46. When the triggering element 5 breaks, e.g. owing to an increase in temperature, the locking means 43 is able to rotate in relation to the support axle 46 so that the first claw part 44 in FIG. 4a moves some distance to the right and the second claw part 45, which locks the support part 41 to the fixing body of the triggering element, into its groove 47, moves upwards and releases the support part 41 from its locking in the groove 47 of the fixing body 4.

A second way to fit the support part of the fixing body of the triggering element to detach can be achieved e.g. in the manner presented in publication WO 98/56463, wherein the holder of the triggering element is fitted to detach.

According to one preferred embodiment the fixing body 4 of the triggering element comprises a spraying nozzle 42 for spraying the medium in the activated state of the spray head.

The spray head is typically fitted into a fire extinguishing system of a public space or of a means of transportation.

The spray head according to the invention is very well suited to spraying an extinguishing medium of high liquid content. As regards the applications and properties of the spray head, reference can be made to publications EP 1150747 and WO01/26742.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1. Spray head, which comprises a spray head body (2), which comprises at least one nozzle (3), a heat-activated triggering element (5), in connection with the spray head of which triggering element a protection means (6) is arranged, which protection means is in front of the nozzle (3) in the protective position and mechanically protects the triggering element (5) when the spray head is in a non-active state, and which protection means (6) can be moved to a second position, in which at least one nozzle (3) and the triggering element (5) are not protected by the protection means (6), characterized in that the triggering element (5) is fitted onto the fixing body (4) of the triggering element, which fixing body can be moved with respect to the spray head body (2) between two positions, a first position in which the spray head is in the non-active state and the fixing body (4) of the triggering element is in the retracted position, and a second position in which the fixing body of the triggering element is pushed out, and which fixing body (4) of the triggering element is arranged to move with respect to the spray head body (2) from the effect of the pressure of the medium from a first position to a second position and at the same time to exert force on the protection means (6), for moving the protection means from the protective position to a second position, in which case the spray head is placed into a state of readiness in the second position of the fixing body of the triggering element.

2. Spray head according to claim 1, characterized in that the medium is an extinguishing medium.

3. Spray head according to claim 1, characterized in that the spray head body (2) comprises a cylinder space (13), and in that at least a part of the fixing body (4) of the triggering element is formed into a piston part, which is arranged to move in the cylinder space (13) from the effect of the pressure of the medium from a first position to a second position.

4. Spray head according to any of claim 1, characterized in that the fixing body (4) of the triggering element comprises a limiting means (12) of movement, such as a shoulder, and the spray head body (2) comprises a countersurface (18) to the limiting means.

5. Spray head according to any of claim 1, characterized in that the triggering element (5) is fitted to extend in the lateral direction with respect to the direction of movement of the fixing body (4) of the triggering element.

6. Spray head according to any of claim 1, characterized in that the fixing body (4) of the triggering element comprises a support part (41), which is fitted to the end of the fixing body (4) of the triggering element on the protection means (6) side, when the protection means (6) protects the triggering element and at least one nozzle (3) of the spray head.

7. Spray head according to any of claim 1, characterized in that in the protective position the protection means (6) is fitted into a aperture (15) of cover board (9), into a mounting box (8), or into a corresponding installation aperture of the spray head.

8. Spray head according to claim 6, characterized in that the support part (41) of the fixing body (4) of the triggering element is fitted to detach when the triggering element (5), such as an ampoule that breaks from the effect of heat, triggers and the spray head activates to spray.

9. Spray head according to any of claim 1, characterized in that the fixing body (4) of the triggering element contains a spraying nozzle (42) for spraying the medium in the activated state of the spray head.

10. Spray head according to any of claim 1, characterized in that the spray head is fitted into a fire extinguishing system of a public space or of a means of transportation.
